(19) United States
(12) Patent Application Publication
(10) Pub. No.: US 2015/0347291 A1
(43) Pub. Date: Dec. 3, 2015

(54) FLASH MEMORY BASED STORAGE SYSTEM AND OPERATING METHOD

(71) Applicant: SAMSUNG ELECTRONICS CO., LTD., SUWON-SI (KR)

(72) Inventors: SANG-HOON CHOI, SEOUL (KR); SOOJEONG KIM, SEONGNAM-SI (KR); HYUNGJIN IM, HWASEONG-SI (KR); MOONSANG KWON, SEOUL (KR)

(21) Appl. No.: 14/721,420

(22) Filed: May 26, 2015

(30) Foreign Application Priority Data
May 29, 2014 (KR) 10-2014-0065309

(51) Int. Cl. G06F 12/02; G06F 3/06

(52) U.S. Cl. CPC G06F 12/0246; G06F 3/0608; G06F 3/064; G06F 3/0652; G06F 3/0679; G06F 2212/1044; G06F 2212/152; G06F 2212/2022; G06F 2212/214; G06F 2212/253; G06F 2212/7205

(57) ABSTRACT

A flash memory based storage system and operating method are provided. A host of the storage system requests an erase unit size from the storage device and uses a multiple of the erase unit size to partition a logical address. Each host block may be assigned a state selected from a group of states including: an open state in which an erase unit of the storage device is allocated, a write state in which data is written at an erase unit of the storage device, a close state in which a write operation is no longer performed, and an invalidate state in which valid data of a host block is invalidated.

### CROSS-REFERENCE TO RELATED APPLICATIONS

A claim for priority under 35 U.S.C. §119 is made to Korean Patent Application No. 10-2014-0065309 filed May 29, 2014, the subject matter of which is hereby incorporated by reference.

### BACKGROUND

The inventive concept relates generally to storage systems, and more particularly, to flash memory based storage systems and associated operating methods.

A storage system includes at least a host and a storage device. The host and storage device are connected via one or more standardized interfaces, such as a serial ATA (SATA), universal flash storage (UFS), small computer small interface (SCSI), serial attached SCSI (SAS), embedded MMC (eMMC), and the like. Within the storage system, the storage device includes at least a nonvolatile memory and a device controller. The nonvolatile memory may be implemented using one or more semiconductor memory chips such as flash memory, MRAM, PRAM, FeRAM, etc.

It is well understood that various forms of nonvolatile memory such as flash memory do not support a direct data overwrite operation. Thus, in order to accomplish the same result, flash memory must perform an erase-before-write operation. This functional characteristic of flash memory necessitates so-called periodic garbage collection operations, where each garbage collection operation generate one or more additional “free blocks” of memory. A typical garbage collection operation includes the steps of selecting a victim block, copying valid pages of data from the victim block to an existing free block, and then erasing the victim block to generate a “new” free block.

Unfortunately, during execution of a garbage collection operation, the number of copy operations increases in proportion to the number of valid pages stored in the victim block and this necessity reduces overall storage device performance. Additionally, the useful life of certain storage devices is reduced by repeated execution of garbage collection operations.

### SUMMARY

In one aspect certain embodiments of the inventive concept provide a flash memory based storage system comprising; a host configured to request erase unit size from a storage device including a flash memory, wherein the storage device is configured to provide the erase unit size related to the flash memory to the host in response to the request for erase unit size, wherein the host is further configured to partition a logical address using a multiple of the erase unit size to generate a plurality of host blocks.

In another aspect certain embodiments of the inventive concept provide an operating method of a flash memory based storage device including a host and a storage device including a flash memory. The method comprises; requesting that erase unit size related to the flash memory be communicated from the storage device to the host and receiving the erase unit size information in the host, and partitioning a logical address using a multiple of the erase unit size to generate a plurality of host blocks.

In another aspect certain embodiments of the inventive concept provide an operating method of a flash memory based storage device including a host storing a logical address and a storage device including a flash memory divided into a plurality of erase units. The method comprises; requesting that erase unit size related to the flash memory be communicated from the storage device to the host, and receiving the erase unit size information in the host and using an integer multiple of the erase unit size to partition the logical address to generate a plurality of host blocks, wherein each one of the host blocks respectively corresponds to at least one of the plurality erase units.

### BRIEF DESCRIPTION OF THE DRAWINGS

The above and other objects and features will become apparent from the following description of exemplary embodiments with reference to the following drawings in which:

FIG. 1 is a block diagram illustrating a storage system;

FIG. 2 is a block diagram illustrating a flash memory-based storage system according to an embodiment of the inventive concept;

FIG. 3 is a block diagram further illustrating the flash memory 2210 of FIG. 2;

FIG. 4 is a partial circuit diagram illustrating a memory block that may be used in the flash memory of FIG. 3;

FIG. 5 is a flowchart summarizing a comparative example of a conventional garbage collection operation;

FIGS. 6, 7, 8, 9, 10, 11, 12, 13 and 14 are respective conceptual diagrams illustrating command/response exchange(s) between the host and storage device of FIG. 2 in the context of various operating states associated with flash memory-based storage system according to an embodiment of the inventive concept;

FIG. 15 is a state transition diagram for a host block of a flash-based storage system;

FIG. 16 is a conceptual diagram describing a multiple host block write;

FIG. 17 is a conceptual diagram illustrating one possible relationship between an erase unit and a plurality of physical blocks;

FIG. 18 is a block diagram further illustrating the flash memory 2210 of FIG. 2 as implemented in a three-dimensional (3D) memory cell arrangement;

FIG. 19 is a perspective view illustrating in one example a 3D structure of a memory block illustrated in FIG. 18;

FIG. 20 is an equivalent circuit for the memory block BLK1 of FIG. 19;

FIG. 21 is a block diagram illustrating a memory card that may include a storage device according to an embodiment of the inventive concept is applied;

FIG. 22 is a block diagram illustrating a solid state drive (SSD) that may include a storage device according to an embodiment of the inventive concept;

FIG. 23 is a block diagram further illustrating the SSD controller 4210 of FIG. 22; and

FIG. 24 is a block diagram illustrating an electronic device that may include a storage device according to an embodiment of the inventive concept.

### DETAILED DESCRIPTION

Certain embodiments of the inventive concept will now be described in detail in some additional detail with reference to the accompanying drawings. The inventive concept, however, may be embodied in various different forms, and should not be construed as being limited to only the illustrated embodiments. Rather, these embodiments are provided as examples so that this disclosure will be thorough and complete, and will fully convey the concept of the inventive concept to those skilled in the art. Unless otherwise noted, like reference numbers and label are used to denote like or similar elements throughout the drawings and written description.

It will be understood that, although the terms “first”, “second”, “third”, etc., may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the inventive concept.

Spatially relative terms, such as “beneath”, “below”, “lower”, “under”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” or “under” other elements or features would then be oriented “above” the other elements or features. Thus, the exemplary terms “below” and “under” can encompass both an orientation of above and below. The device may be otherwise oriented (rotated 90 degrees or at other orientations) and the spatially relative descriptors used herein interpreted accordingly. In addition, it will also be understood that when a layer is referred to as being “between” two layers, it can be the only layer between the two layers, or one or more intervening layers may also be present.

The terminology used herein is for the purpose of describing particular embodiments only and is not intended to be limiting of the inventive concept. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Also, the term “exemplary” is intended to refer to an example or illustration.

It will be understood that when an element or layer is referred to as being “on”, “connected to”, “coupled to”, or “adjacent to” another element or layer, it can be directly on, connected, coupled, or adjacent to the other element or layer, or intervening elements or layers may be present. In contrast, when an element is referred to as being “directly on,” “directly connected to”, “directly coupled to”, or “immediately adjacent to” another element or layer, there are no intervening elements or layers present.

Unless otherwise defined, all terms (including technical and scientific terms) used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and/or the present specification and will not be interpreted in an idealized or overly formal sense unless expressly so defined herein.

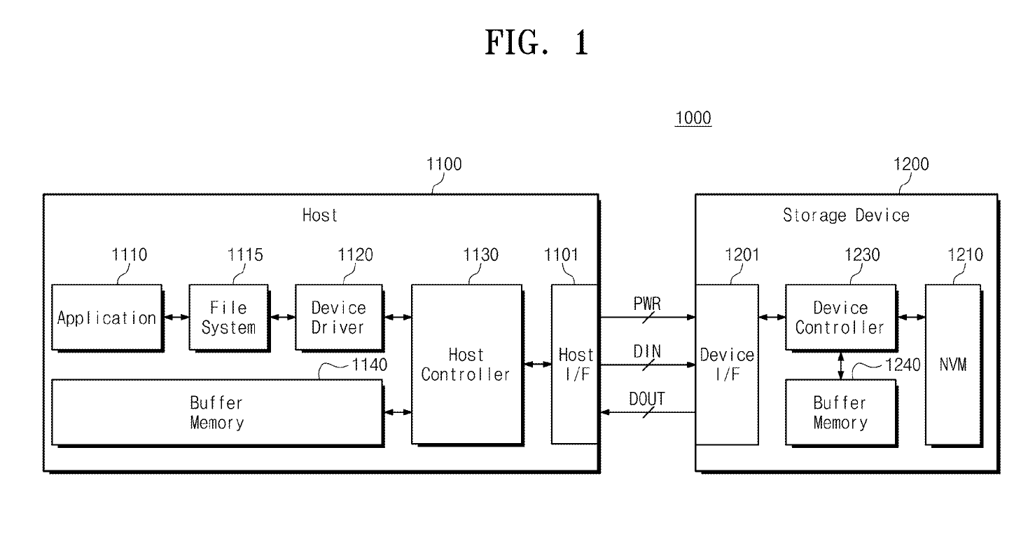

Figure (FIG. 1 is a block diagram illustrating a storage system according to an embodiment of the inventive concept. Referring to FIG. 1, a storage system 1000 comprises a host 1100 and a storage device 1200. The host 1100 and the storage device 1200 may be connected via one or more standardized interfaces such as a serial ATA (SATA), universal flash storage (UFS), small computer small interface (SCSI), serial attached SCSI (SAS), embedded MMC (eMMC), and the like.

As illustrated in FIG. 1, a host interface 1101 and a device interface 1201 are connected through data lines DIN and DOUT for exchanging data, address information, and/or control signals, as well as a power signals. Here, one or more power line(s) PWR are assumed to provide one or more power signals from the host 1100 to the storage device 1200. The host 1100 is further assumed to be capable of executing an application 1110 using a constituent file system 1115 and one or more device driver(s) 1120. In the illustrated example of FIG. 1, a host controller 1130 and buffer memory 1140 as assumed to cooperate in the execution of the application 1110.

The application 1110 may be one or many different software programs designed for execution by the host 1100. The file system 1115 organizes to store files or data in one or more designated areas of the buffer memory 1140, and/or the storage device 1200. The file system 1115 may be used according to a specific operating system running on the host 1100.

The device driver 1120 may include one or more drivers associated with peripheral device(s) that are used through connection with the host 1100. Thus, the device driver 1120 may be used to drive the operation of the storage device 1200. The application 1110, file system 1115, and device driver 1120 may be implemented using software and/or firmware. The host controller 1130 exchanges data with the storage device 1200 via the host interface 1101.

Not only may the buffer memory 1140 be used as a main memory and/or cache memory for the host 1100, but it may also be used as a drive memory for software being executed by the host 1100, such as the application 1110, file system 1115, and device driver 1120.

The storage device 1200 is connected to the host 1100 through the device interface 1201. The storage device 1200 illustrated in FIG. 1 includes a nonvolatile memory 1210, a device controller 1230, and a buffer memory 1240. The nonvolatile memory 1210 may include, but is not limited to, flash memory, MRAM, PRAM, FeRAM, and the like. The device controller 1230 controls the overall operation of the nonvolatile memory 1210 including at least the execution of write, read and/or erase operations. The device controller 1230 exchanges data with the nonvolatile memory 1210 or the buffer memory 1240 through an address or data bus.

The buffer memory 1240 may be used to temporarily store data read from, or to be written to, the nonvolatile memory 1210. The buffer memory 1240 may be implemented using volatile memory and/or nonvolatile memory.

The storage system 1000 of FIG. 1 is applicable to various mobile devices and other electronic devices that use flash memory. Hereafter, a flash memory based solid state drive (SSD) will be described as one possible application for the storage system 1000 and related operating methods.

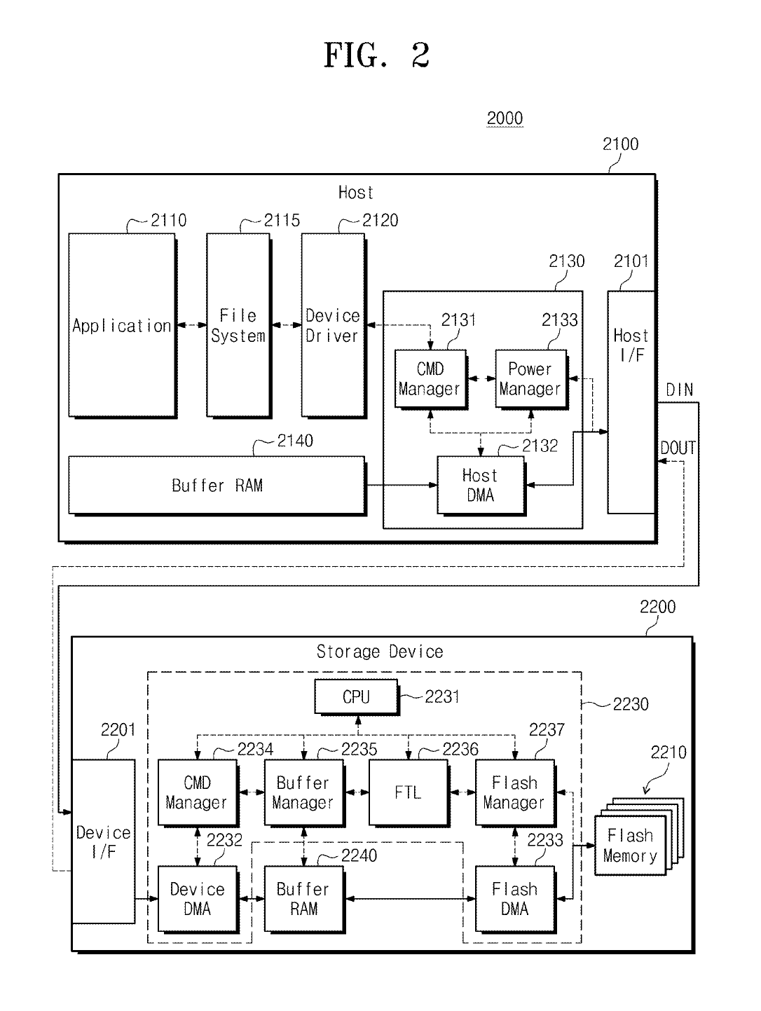

FIG. 2 is a block diagram illustrating a flash memory-based storage system according to an embodiment of the inventive concept. Referring to FIG. 2, a storage system 2000 includes a host 2100 and a storage device 2200.

As before, the host 2100 is configured to run an application 2110, file system 2115, and/or device driver 2120 using a host controller 2130 and buffer RAM 2140. Further, the host controller 2130 includes a command manager 2131, host DMA 2132 and power manager 2133. The command manager 2131, host DMA 2132, and power manager 2133 may be variously implemented as operating algorithm(s), software routine(s), and/or firmware capable of being executed using host controller 2130 resources.

A command, such as a write command, generated by the application 2110, file system 2115, or device driver 2120 may be managed in its provision of and response to the host 2100 using the command manager 2131 of the host controller 2130. The command manager 2131 may sequentially manage commands to be provided to the storage device 2200 using the host DMA 2132. The host DMA 2132 sends the commands to the storage device 2200 via a host interface 2101.

In FIG. 2, the storage device 2200 includes a flash memory 2210, device controller 2230, and buffer RAM 2240. The device controller 2230 includes a Central Processing Unit (CPU) 2231, device DMA 2232, flash DMA 2233, command manager 2234, buffer manager 2235, flash translation layer (FTL) 2236, and flash manager 2237.

The command manager 2234, buffer manager 2235, FTL 2236, and flash manager 2237 may be implemented in algorithm, software, and/or firmware form for execution by the device controller 2230.

A command provided from the host 2100 to storage device 2200 is provided to the device DMA 2232 via a device interface 2201. The device DMA 2232 communicates the input command to the command manager 2234. The command manager 2234 allocates the buffer RAM 2240 to receive data via the buffer manager 2235. Once ready to transfer data, the command manager 2234 will send a transmission ready complete signal to the host 2100.

The host 2100 may send data to the storage device 2200 in response to the transmission ready complete signal. The data may be sent to the storage device 2200 through the host DMA 2132 and the host interface 2101. The storage device 2200 stores the received data in the buffer RAM 2240 through the device DMA 2232 and the buffer manager 2235. The data stored in the buffer RAM 2240 is provided to the flash manger 2237 via the flash DMA 2233. The flash manager 2237 stores data at a selected address of the flash memory 2210 in accordance with address mapping information provided by the FTL 2236.

Once a data transfer operation and program operation associated with a command are completed, the storage device 2200 will send a response signal to the host 2100 via an interface in order to inform the host 2100 that the command has been completed. Based on a response signal, the host 2100 informs the device driver 2120, file system 2115, and application 2110 whether or not the received command is complete and terminates operation(s) associated with the command.

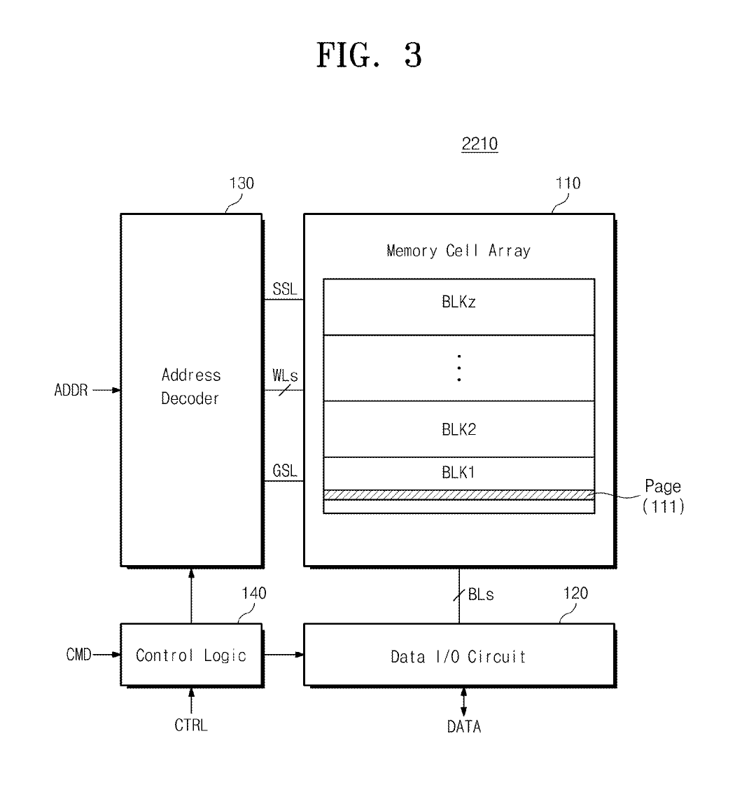

FIG. 3 is a block diagram further illustrating in one example the flash memory 2210 of FIG. 2. Referring to FIG. 3, the flash memory 2210 includes a memory cell array 110, data input/output (I/O) circuit 120, address decoder 130, and control logic 140.

The memory cell array 110 contains a plurality of memory blocks BLK1 to BLKn, each of which is formed of a plurality of pages. Each page may be formed of a plurality of memory cells. The flash memory 2210 performs an erase operation by the memory block and a write or a read operation by the page.

Each memory cell may be used to store single-bit data (i.e., a single-level memory cell or SLC) or multi-bit data (i.e., a multi-level memory cell or MLC). Each SLC will have an erase state or a program state based on its threshold voltage.

Each MLC will have an erase state or one of a plurality of program states based on its threshold voltage. The flash memory 2210 may include SLC and/or MLC.

The data I/O circuit 120 is connected with the memory cell array 110 via a plurality of bit lines. Thus, during a program operation, the data I/O circuit 120 receives “program data” from an external device to be programmed to a selected page 111 of the memory cell array 110, and during a read operation, the data I/O circuit 120 will read data from the selected page 111 to thereafter provide to an external device.

The address decoder 130 is connected with the memory cell array 110 via a plurality of word lines. The address decoder 130 selects a memory block or a page in response to an address ADDR. Herein, an address for selecting a memory block may be named a block address, and an address for selecting a page may be named a page address. Below, it is assumed that one page 111 of a first memory block BLK1 is selected.

The control logic 140 may be used to control programming, erasing, and reading of data in relation to the flash memory 1000. For example, during a program operation, the control logic 140 controls the address decoder 130 such that a program voltage is supplied to a selected word line and the data I/O circuit 120 such that data is programmed at the selected page 111. The control logic 140 controls the programming, erasing, and reading of data in relation to the flash memory 1000 in accordance with one or more control signals CTRL received from the device controller 2230. (See, FIG. 2).

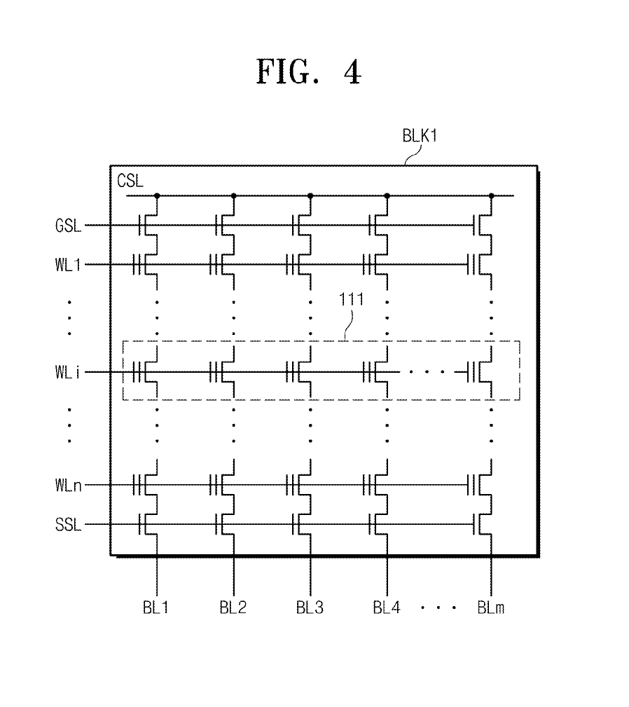

FIG. 4 is a partial circuit diagram illustrating a memory block that may be used in the memory cell array 110 of FIG. 3. Referring to FIG. 4, a memory block BLK1 is assumed to have a cell string structure. Each cell string includes a string selection transistor connected to a string selection line SSL, memory cells connected to word lines WL1 to WLn, and a ground selection transistor connected to a ground selection line GSL. The string selection transistors are connected to bit lines BL1 to BLm, and the ground selection transistors are connected to a common source line CSL.

A word line (e.g., WLi) is connected with a plurality of memory cells. A set of memory cells that are connected to the selected word line WLi and are simultaneously programmed is named “page”. In FIG. 4, the selected page 111 may experience simultaneous programming, where the page may be divided into a main area for storing main data and a spare area for storing additional data, such as parity bits.

Returning to FIG. 2, the storage device 2200 is assumed to internally performs garbage collection. However, as noted above, garbage collection causes an increase in variability of read/write latency and may reduce the useful lifetime of memory cells. Accordingly, the storage system 2000 is configured such that garbage collection in the conventional sense (or using conventional approaches) is not performed in relation to the storage device 2200, thereby improving performance and elongating the useful lifetime of memory cells.

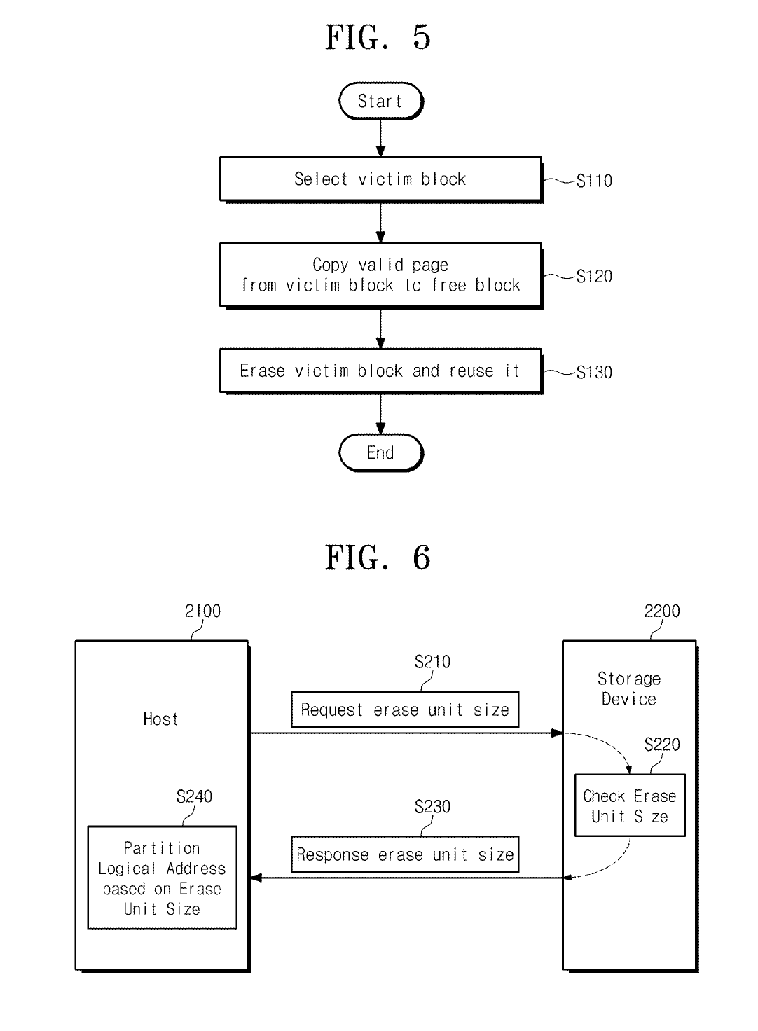

FIG. 5 is a flowchart summarizing a comparative garbage collection operation that may be executed by a conventional flash memory based storage device. In step S110, the storage device selects a victim block. In step S120, the storage device copies valid data pages from the victim block to a free block. In step S130, the storage device erases the victim block. The erased victim block then becomes a free block. However, in order to avoid the negative effects of garbage collection previously noted, the storage system 2000 of FIG. 2 need not perform the second step (i.e., step S120) of the comparative garbage collection operation. That is, during garbage collection operations according to embodiments of the inventive concept, the copying of valid data pages essentially need not be performed, such as when a victim block does not include at least one valid page. In this regard, embodiments of the inventive concept may define a new or modified garbage collection command that is exchanged between the host 2100 and storage device 2200 when a victim block include no valid pages.

FIG. 6 is a conceptual diagram illustrating a command/response sequence between a host and storage device, such as the host and storage device of FIG. 2. Referring to FIG. 6, a host 2100 requests an erase unit size from the storage device 220 (step S210). Then, the storage device 2200 internally determines an erase unit size in relation to (e.g.,) the flash memory 2210 in response to the request for erase unit size (step S220). Then, the storage device 2200 provides the host 2100 with the requested erase unit size (step S230). Here, the term “erase unit size” means an erase unit defined for the flash memory 2210. For example, the erase unit size may be one memory block of the memory cell array 110. (See, FIG. 3). Alternately, the erase unit size may be two or memory blocks that are erased at the same time.

Regardless of actual erase unit size, the host 2100 receives information indicating the erase unit size from the storage device 2200 and partitions at least one logical address (step S240). A logical address partition unit of the host 2100 may correspond to the erase unit size provided from the storage device 2200. The host 2100 uses the erase unit size or ‘N’ times the erase unit size, where N is an integer greater than 1, as a basic unit to partition a logical address. Hereafter, each of partitioned areas of the logical address will be referred to as a “host block”.

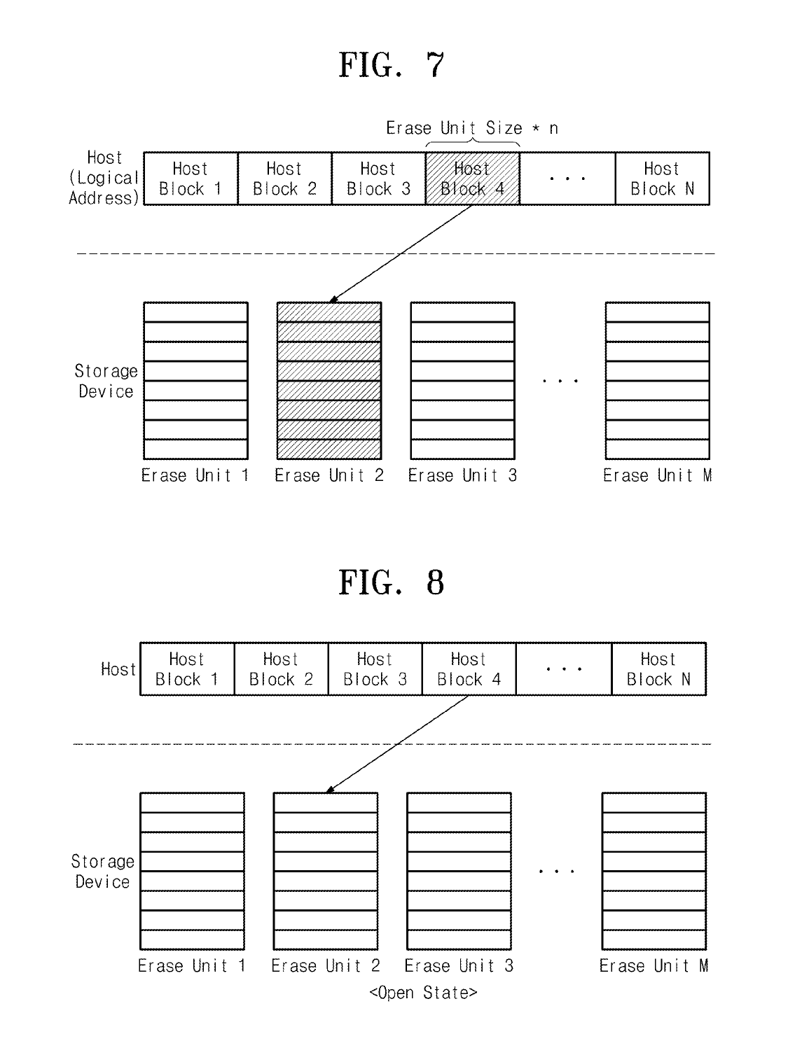

FIG. 7 is a conceptual diagram illustrating partitioned areas of a logical address of a host consistent with the approach described in relation to FIG. 6. Referring to FIGS. 2, 6 and 7, the host 2100 divides a logical address into N segments (or host blocks) based on erase unit size information provided by the storage device 2200. As illustrated in FIG. 7, the logical address is divided into a plurality of host blocks 1 through N. Here, the first segment of the logical address may be referred to as host block 1, the second segment as host block 2, and so on.

Referring to FIG. 7, the storage device 2200 is assumed to include ‘M’ erase units. That is, the storage device 2200 is assumed to operate in response to erase commands in accordance with 1 through M erase units. Thus, the erase units shown in FIG. 7 are logical blocks identified by a corresponding logical address provided by the host 2100. Each logical block corresponds to at least a physical block of the flash memory 2210. The relationships between logical blocks and physical blocks may be managed using one or more mapping table(s). The mapping table(s) may be used in conjunction with the FTL 2236 of the storage device 2200.

Referring to FIG. 7, each erase unit includes a plurality of logical pages (e.g., eight logical pages as one working example). So in the illustrated example of FIG. 7, a fourth host block may correspond to a second erase unit, where the second erase block includes one or more physical blocks. Thus, a host block may correspond to one or more physical block(s) of the flash memory 2210.

Hence, the fourth host block illustrated in FIG. 7 corresponds to a number of erase units, and the host 2100 is provided with erase unit size information from the storage unit 2200 sufficient to allocate a host block according to one or more erase units.

In the storage system 2000 of FIG. 2, the host 2100 may be used to manage a host block corresponding to (or “aligned with”) multiple erase unit(s). This makes it possible to eliminate the copying valid page step as described above when the storage device 2200 performs a garbage collection operation. This result will be described in some additional detail hereafter.

In the foregoing context, the host block may be set up during an initialization procedure that is executed (e.g.,) when the storage device 2200 is connected to the host 2100. Further, the host block may be assigned one state from a group of states comprising; an open state, a write state, an invalidate state, and a close state. Here, the host block will be assigned a state according to the state of the corresponding erase unit, and the host 2100 may perform different operations depending on the particular state of the host block.

FIG. 8 is a conceptual diagram describing an open state for the host block shown in FIG. 7. In case where the host block is assigned an open state, the host 2100 requests a write ready operation on a host block at the storage device 2200. That is, the host 2100 requests a write ready operation on an erase unit allocated to a host block.

Upon receiving a request for transition to an open state, the storage device 2200 may newly allocate an erase unit. FIG. 8 shows an example where the second erase unit is newly allocated. Data write requested after the erase unit is allocated may be stored in the allocated erase unit. Differing host and/or storage device venders may use different commands for a state transition to an open state. Also, the host 2100 may assign the host block an open state using the argument of a write command or a logical address of a host block.

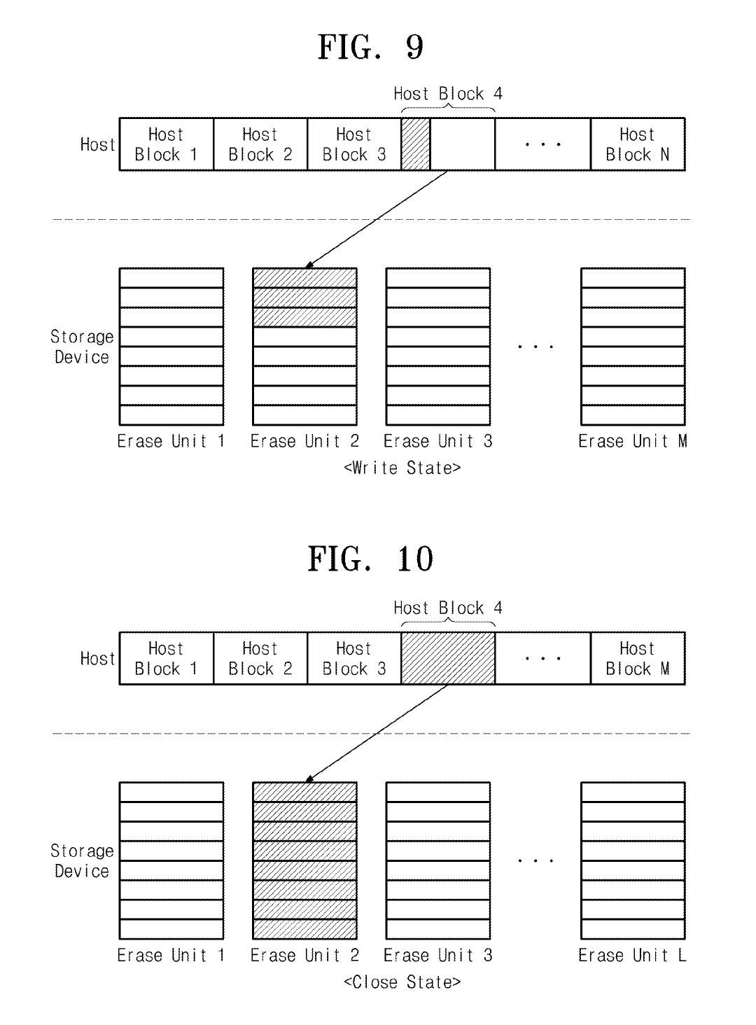

FIG. 9 is a conceptual diagram describing a write state for the host block shown in FIG. 7. In case a host block is at a write state, a host 2100 requests a write operation on a host block at a storage device 2200. In response to a write request on a selected host block, the storage device 2200 performs a write operation on an erase unit allocated to the host block. The size of write requested data may be equal to or less than the size of a host block. In FIG. 9, the shaded segment indicates data stored in a second erase unit allocated to a fourth host block.

FIG. 10 is a conceptual diagram describing a close state for the host block shown in FIG. 7. In case of a close state, a write operation on a host block is no longer performed. A separate vendor command may be used for a state transition to a close state. The host 2100 makes the host block into a close state through argument of a write command or a logical address of a host block.

In FIG. 10, in case a write operation on a fourth host block is completed by the host 2100, the host 2100 issues an end request to a storage device 2200 using a vendor command. If receiving the end request, the storage device 2200 may not write data at a second erase unit allocated to the fourth host block any longer. Meanwhile, if the number of erase units in use increases, the amount of a memory consumed may increase. To reduce the amount of a memory consumed, the host 2100 provides the storage device 2200 with information on a host block where a write operation is completed.

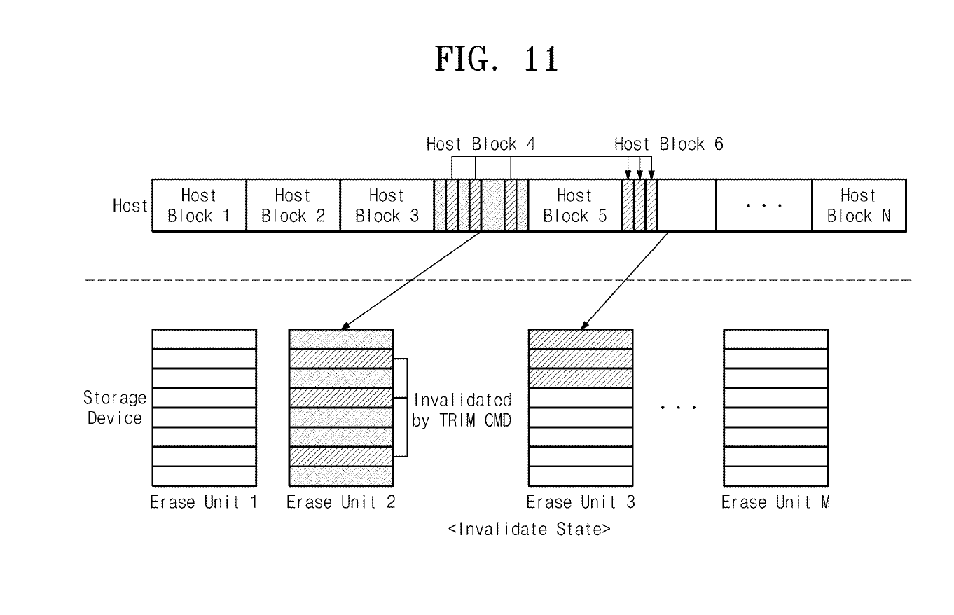

FIGS. 11, 12, 13 and 14 are respective conceptual diagrams describing an invalidate state for the host block shown in FIG. 7. In case a host block is at an invalidate state, a host 2100 moves valid data of a host block (hereinafter, referred to as a source host block) to another host block (hereinafter, referred to as a target host block). If the invalidate state is completed, the source host block may not include valid data any longer.

That the source host block no longer includes valid data may mean that no valid data exists in an erase unit allocated to the source host block. For this reason, the storage system 2000 of FIG. 2 may not perform a valid page copying operation corresponding to step S120 of the method shown in FIG. 5. Thus, embodiments of the inventive concept do not perform the step of the valid page copying. Instead, a new erase unit is generated.

FIG. 11 is a conceptual diagram illustrating an example where a fourth host block transitions to an invalidate state. Referring to FIGS. 2, 6, 7 and 11, the host 2100 moves valid data from the fourth host block to a sixth host block. The host 2100 iterates the procedure by reading valid data of the fourth host block having an invalidate state and writing the read valid data at the sixth host block. The host 2100 iterates such a procedure until all data of the fourth host block is invalidated. If valid data is all moved, the host 2100 may issue a trim command to a storage device 2200. The storage device 2200 invalidates valid data of a second erase unit in response to the trim command.

Herein, to invalidate valid data of the second erase unit means to remove a mapping relationship between logical addresses and physical addresses that is registered in a mapping table.

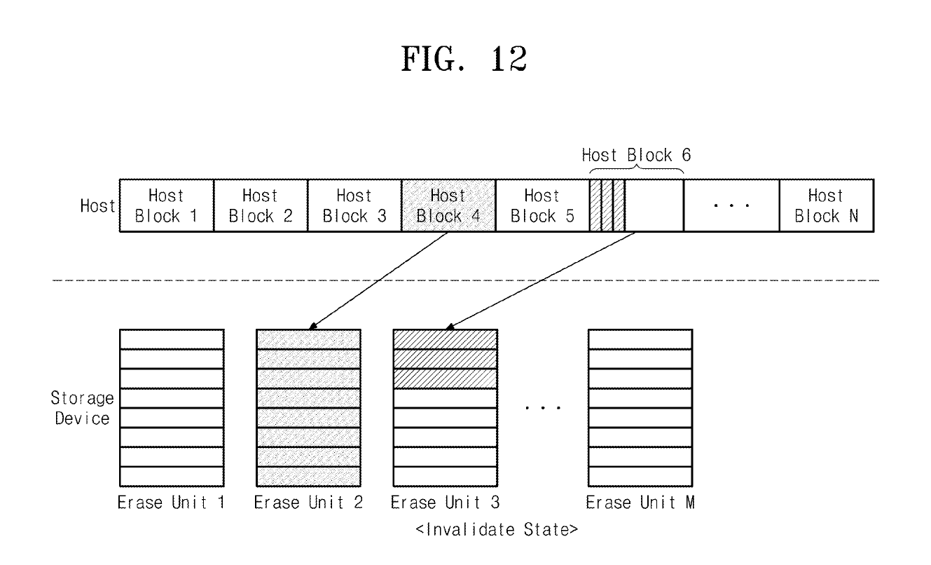

FIG. 12 is a conceptual diagram illustrating an example where no valid data remains at a second erase unit by moving valid data of the fourth host block to the sixth host block, and removing a mapping relationship from a mapping table in response to a trim command provided by the host 2100 to the storage device 2200.

Referring to FIG. 12, if all valid data of a fourth host block is moved into a sixth host block, no valid data may remain at a second erase unit that has stored data information of the fourth host block. Now that the second erase unit no longer stores valid data, the storage device 2200 does not need to perform a valid page copying operation on the second erase unit. This may mean that the storage device 2200 performs instantly without a valid page copying operation on the second erase unit.

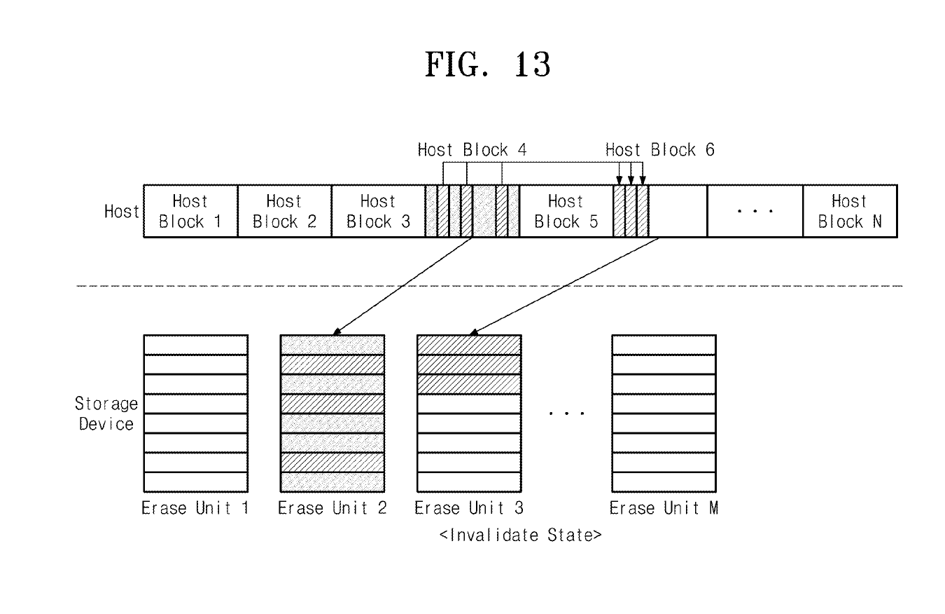

FIG. 13 is a conceptual diagram illustrating an example where the fourth host block is set to an invalidate state without a trim command. That is, the host 2100 need not issue a trim command to a storage device 2200 after valid data of the fourth host block of an invalidate state is moved to the sixth host block. Invalidating valid data of a second erase unit may be made through a state transition of the fourth host block.

Referring to FIG. 13, after all valid data of the fourth host block is moved to the sixth host block, valid data remains in the second erase unit. If the fourth host block experiences state transitions (open state write close state), overwriting may occur at a location where valid data has been stored. If overwriting occurs, an area where valid data is stored may be switched into a new data area through mapping update. In this case, invalidated is an area where valid data is stored. That is, valid data no longer remains.

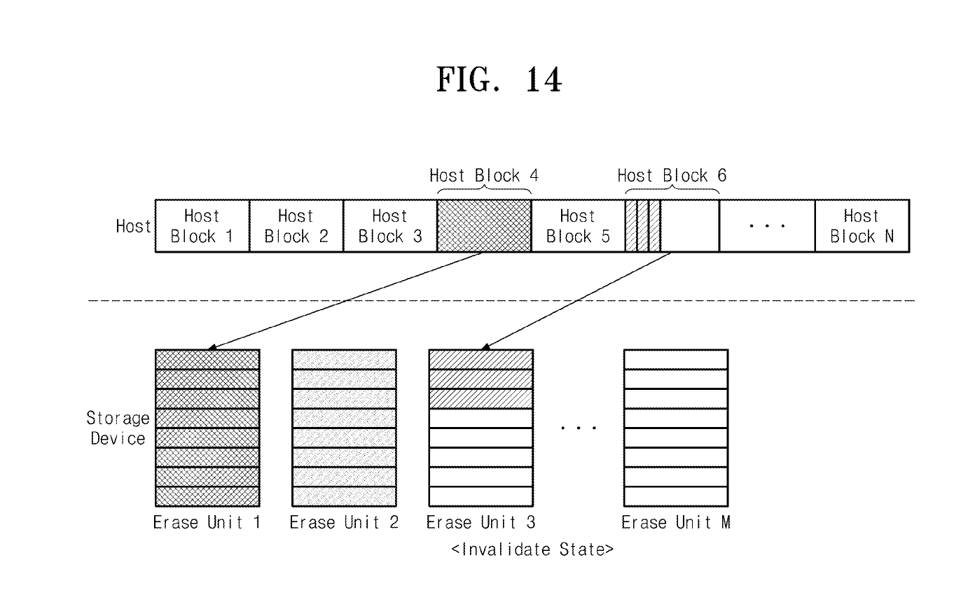

FIG. 14 is a conceptual diagram illustrating an example where a second erase unit shown in FIG. 13 is invalidated without a trim command. Referring to FIG. 14, if all valid data of the fourth host block is moved to the sixth host block, the fourth host block may be switched to a write state from an open state.

At the write state, if filled with new data, the fourth host block may be allocated to a new erase block, for example, a first erase block. In this case, since mapping information is updated, valid data of the second erase unit is invalidated. The second erase unit is made into a free block only through an erase operation without a valid data copying operation.

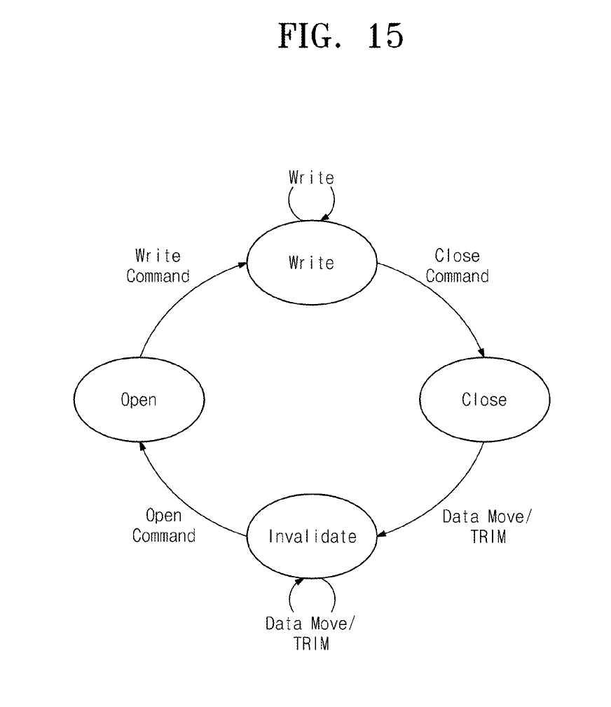

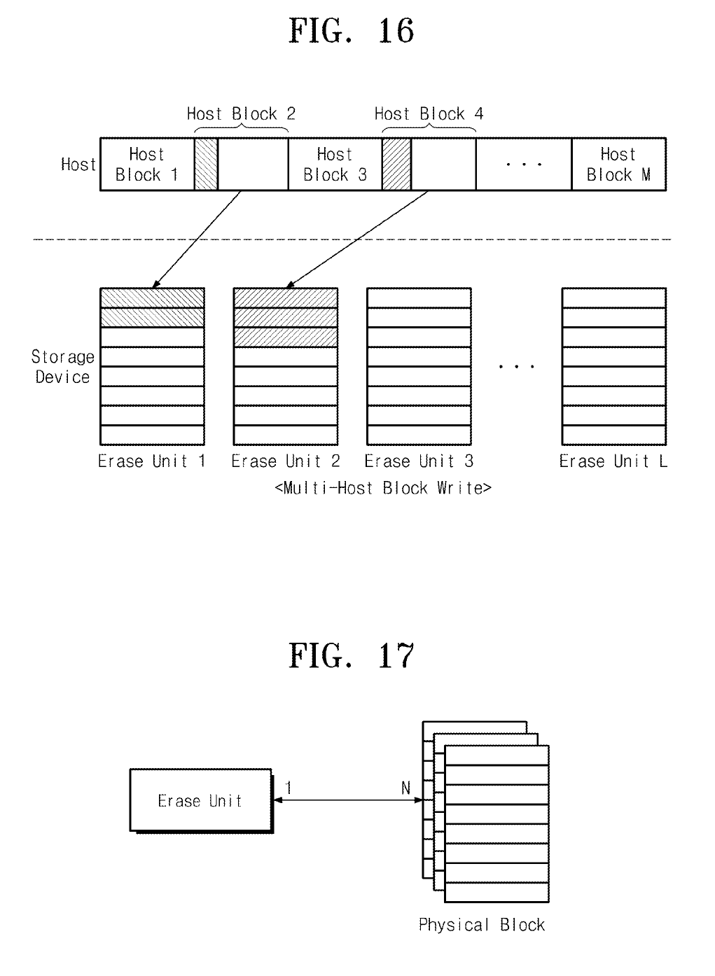

FIG. 15 shows one possible example of a state transition diagram for a host block. Referring to FIG. 15, a host block issues a write command and is set to a write state from an open state. The host block provides a close command and experiences state transitions: write state→close state→invalidate state. The host block provides an open command and experiences a state transition: invalidate state→open state. Here, the close state may be selectively performed. That is, the host block may only have an open state, a write state, and an invalidate state.

The host 2100 invalidates a source host block by moving valid data of the source host block into a target host block or providing a trim command. At this time, an erase unit allocated to the source host block is perfectly invalidated, which enables generating a free block without a valid data copying operation of garbage collection.

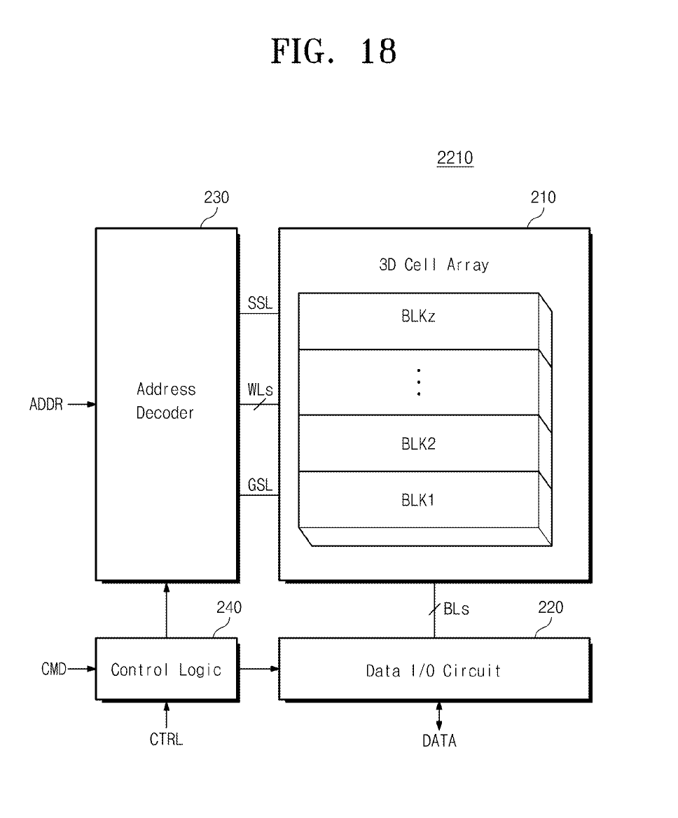

FIG. 16 is a conceptual diagram describing multiple host block write. Here, two or more host blocks are set to a write state. If the host 2100 requesting writing to a plurality of host blocks, the storage device 2200 may divide write requested data into erase units respectively allocated to host blocks and may store it at the erase units. Referring to FIG. 16, second and fourth host blocks may be at a write state. If the host 2100 requesting writing on the second and fourth host blocks, the storage device may divide write requested data into first and second erase units respectively allocated to the second and fourth host blocks and may store it at the first and second erase units.

FIG. 17 is a conceptual diagram illustrating one possible relationship between an erase unit and a plurality of physical blocks. The flash memory 2110 may perform an erase operation where two or more memory blocks are erased at the same time. The memory blocks erased at the same time form an erase unit. The host 2100 divides the logical address, based on an erase unit provided from the storage device 2200. Each of partitioned areas of the logical address has the size corresponding to a multiple of one erase unit.

As described above, a new command may be defined between a host and a storage device to prevent garbage collection from being performed in the storage device. This may be called an “anti-garbage command”. In the anti-garbage command, the host requests erase unit size information, and the storage device provides the erase unit size information in relation to its constituent memory form, e.g., flash memory. The host partitions a logical address using the erase unit size information, and sets the partitioned segments to host blocks, respectively. Each host block may experience state transitions according to a defined state transition order, such as: Open state→Write state→Close state→Invalidate state.

Garbage collection according to certain embodiments of the inventive concept need not cause a valid page copying operation because no valid pages remain in an erase unit, thereby preventing the reduction of memory system performance due to garbage collection and the commensurate reduction in memory cell lifetime.

Not only is a user device according to an embodiment of the inventive concept applied to a two-dimensional flash memory, but it is applied to a three-dimensional flash memory.

FIG. 18 is a block diagram illustrating in one example a three-dimensional (3D) flash memory that may be used in certain embodiments of the inventive concept. Referring to FIG. 18, a flash memory 2210 may include a three-dimensional (3D) cell array 210, a data input/output circuit 220, an address decoder 230, and control logic 240.

The data input/output circuit 220 is connected with the 3D cell array 210 via a plurality of bit lines. The data input/output circuit 220 receives data from an external device or outputs data read from the 3D cell array 210 to the external device. The address decoder 230 is connected with the 3D cell array 210 via a plurality of word lines and selection lines GSL and SSL. The address decoder 230 selects a word line in response to an address ADDR.

The control logic 240 controls operations of the flash memory 2210 including a read operation, a program operation, an erase operation, and so on. For example, at a program operation, the control logic 240 controls the address decoder 230 such that a program voltage is supplied to a selected word line and the data input/output circuit 220 such that data is programmed.

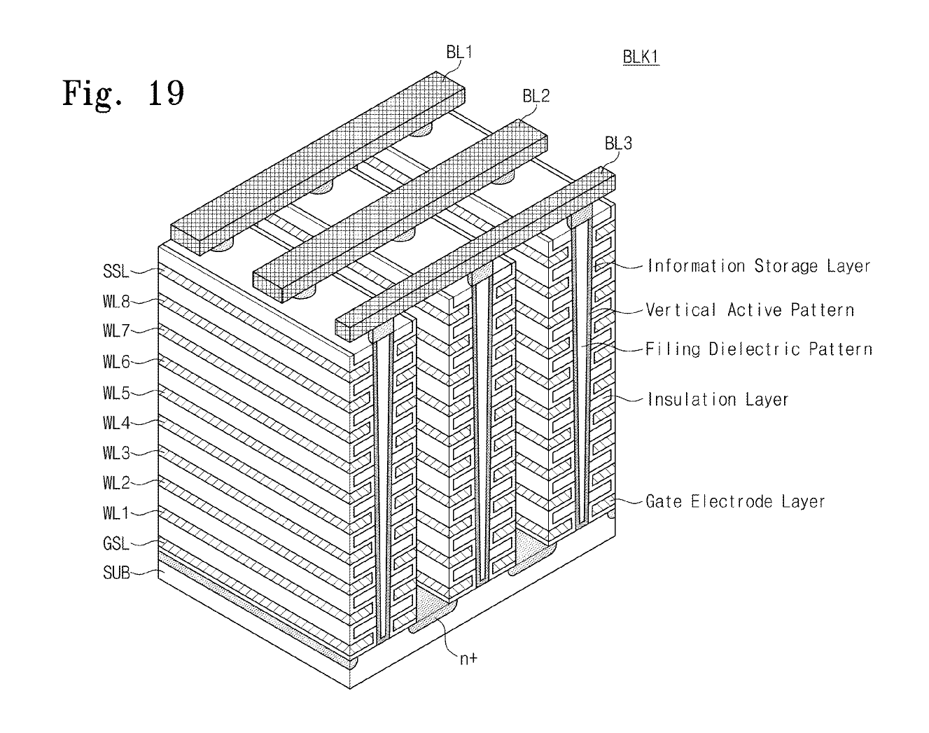

FIG. 19 is a perspective view illustrating one possible 3D structure for the memory block illustrated in FIG. 18. Referring to FIG. 19, a memory block BLK1 is formed in a direction perpendicular to a substrate SUB. An n+ doping region is formed in the substrate SUB.

A gate electrode layer and an insulation layer are deposited above the substrate SUB in turn. An information storage layer is formed between the gate electrode layers and the insulation layers.

V-shaped pillars are formed when the gate electrode layer and the insulation layer are patterned in a vertical direction. The pillars are in contact with the substrate SUB via the gate electrode layers and the insulation layers. In each pillar, an outer portion may be a vertical active pattern and may be formed of channel semiconductor and an inner portion may be a filling dielectric pattern and may be formed of an insulation material such as silicon oxide.

The gate electrode layers of the memory block BLK1 may be connected with a ground selection line GSL, a plurality of word lines WL1 to WL8, and a string selection line SSL. The pillars of the memory block BLK1 are connected with a plurality of bit lines BL1 to BL3. In FIG. 19, one memory block BLK1 is illustrated as having two selection lines SSL and GSL, eight word lines WL1 to WL8, and three bit lines BL1 to BL3. However, the inventive concept is not limited thereto.

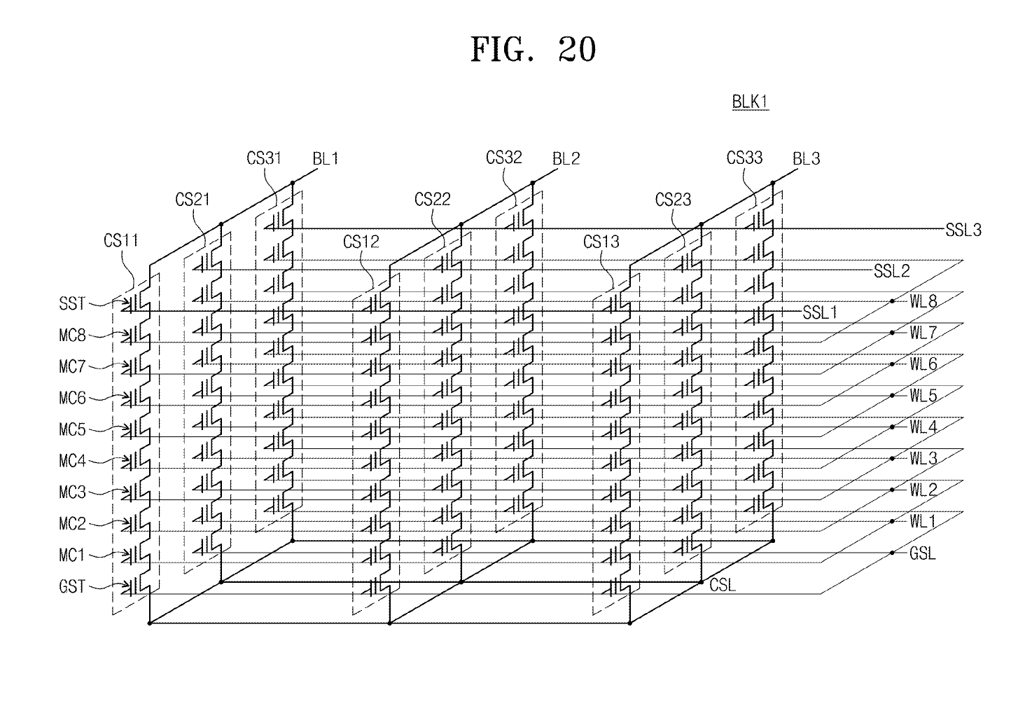

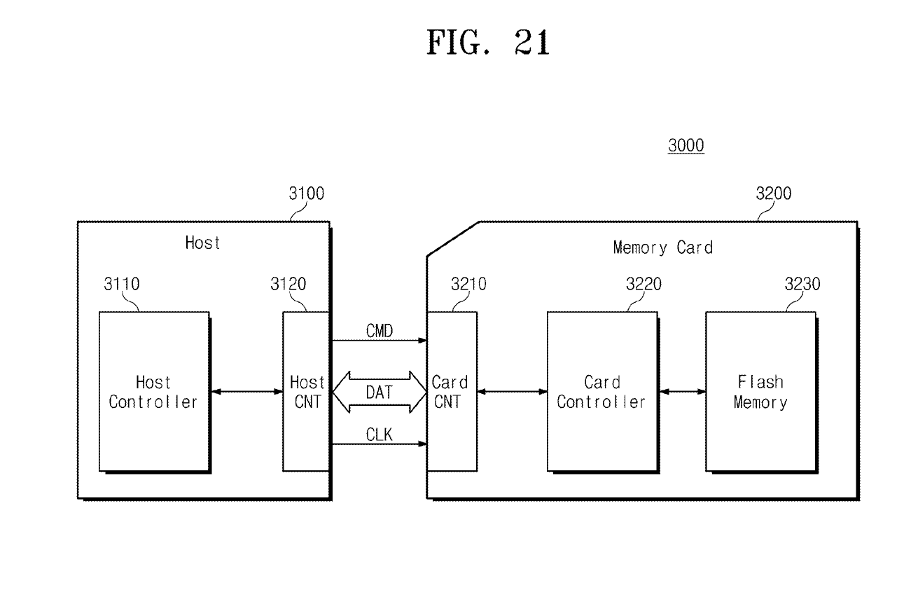

FIG. 20 is an equivalent circuit diagram for the memory block BLK1 of FIG. 19. Referring to FIG. 20, cell strings CS11 to CS33 are connected between bit lines BL1 to BL3 and a common source line CSL. Each cell string (e.g., CS11) includes a string selection transistor SST, a plurality of memory cells MC1 to MC8, and a ground selection transistor GST.

The string selection transistors SST are connected with string selection lines SSL1 to SSL3. The memory cells MC1 to MC8 are connected with corresponding word lines WL1 to WL8, respectively. The ground selection transistors GST are connected with a ground selection line GSL. In each cell string, the string selection transistor SST is connected with a bit line, and the ground selection transistor GST is connected with the common source line CSL.

Memory cells MC1 to MC8 are connected to corresponding word lines WL1 to WL8, and a group of memory cells that are connected to a word line and are simultaneously programmed are named a page. The memory block BLK1 is constituted by a plurality of pages. Also, a word line is connected with a plurality of pages. Referring to FIG. 20, a word line (e.g., WL4) with the same height from the common source line CSL may be connected in common to three pages.

Meanwhile, a user device according to an embodiment of the inventive concept may be applied to or used in various products. The user device according to an embodiment of the inventive concept may be implemented in electronic devices, such as, but not limited to, a personal computer, a digital camera, a camcorder, a handheld phone, an MP3 player, a PMP, a PSP, a PDA, and so on. A storage medium of the user device may be implemented with storage devices, such as, but not limited to, a memory card, a USB memory, a solid state drive (SSD), and so on.

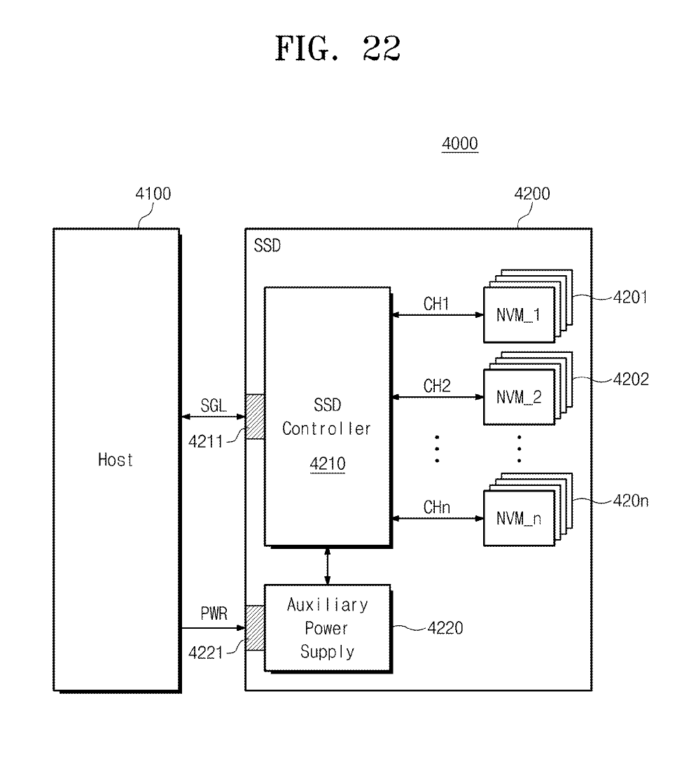

FIG. 21 is a block diagram illustrating a memory card to which a storage device of a user device according to an embodiment of the inventive concept may be applied. A memory card system 3000 includes a host 3100 and a memory card 3200. The host 3100 contains a host controller 3110 and a host connection unit 3120. The memory card 3200 includes a card connection unit 3210, a card controller 3220, and a flash memory 3230.

The host 3100 writes data at the memory card 3200 and reads data from the memory card 3200. The host controller 3110 provides the memory card 3200 with a command (e.g., a write command), a clock signal CLK generated from a clock generator (not shown) in the host 3100, and data through the host connection unit 3120.

The card controller 3220 stores data at the flash memory 3230 in response to a command input through the card connection unit 3210. The data is stored in synchronization with a clock signal generated from a clock generator (not shown) in the card controller 3220. The flash memory 3230 stores data transferred from the host 3100. For example, in case the host 3100 is a digital camera, the memory card 3200 may store image data.

FIG. 22 is a block diagram illustrating a solid state drive to which a storage device according to the inventive concept may be applied. Referring to FIG. 22, a solid state drive (SSD) system 4000 includes a host 4100 and an SSD 4200.

The SSD 4200 exchanges signals SGL with the host 4100 through a signal connector 4211 and is supplied with a power through a power connector 4221. The SSD 4200 includes a plurality of flash memories 4201 to 420n, an SSD controller 4210, and an auxiliary power supply 4220.

The plurality of flash memories 4201 to 420n may be used as a storage medium of the SSD 4200. Not only may the SSD 4200 employ the flash memory, but it may employ nonvolatile memory devices. The flash memories 4201 to 420n are connected with the SSD controller 4210 through a plurality of channels CH1 to CHn. One channel is connected with one or more flash memories. Flash memories connected with one channel may be connected with the same data bus.

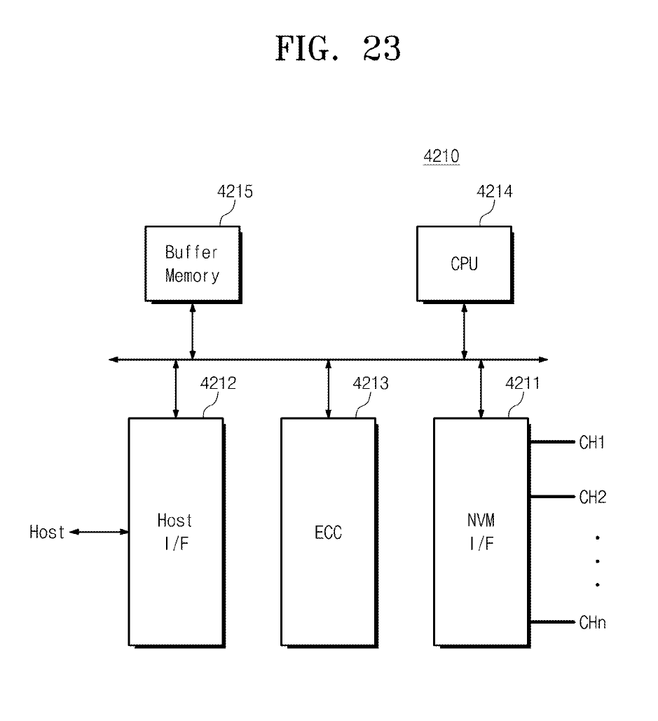

The SSD controller 4210 exchanges signals SGL with the host 4100 through the signal connector 4211. The signals SGL may include a command, an address, data, and so on. The SSD controller 4210 is adapted to write or read out data to or from a corresponding flash memory according to a command of the host 4100. The SSD controller 4210 will be more fully described with reference to FIG. 23.

The auxiliary power supply 4220 is connected with the host 4100 through the power connector 4221. The auxiliary power supply 4220 is charged by a power PWR from the host 4100. The auxiliary power supply 4220 may be placed inside or outside the SSD 4200. For example, the auxiliary power supply 4220 may be put on a main board to supply an auxiliary power to the SSD 4200.

FIG. 23 is a block diagram further illustrating in one example the SSD controller of FIG. 22. Referring to FIG. 23, an SSD controller 4210 includes an NVM interface 4211, a host interface 4212, an ECC circuit 4213, a central processing unit (CPU) 4214, and a buffer memory 4215.

The NVM interface 4211 may scatter data transferred from the buffer memory 4215 into channels CH1 to CHn. The NVM interface 4211 transmits data read from flash memories 4201 to 420n to the buffer memory 4215. The NVM interface 4211 may use a flash memory interface manner, for example. That is, the SSD controller 4210 may perform a read, a write, and an erase operation according to the flash memory interface manner.

The host interface 4212 may provide an interface with an SSD 4200 according to the protocol of the host 4100. The host interface 4212 may communicate with the host 4100 using USB (Universal Serial Bus), SCSI (Small Computer System Interface), PCI express, ATA, PATA (Parallel ATA), SATA (Serial ATA), SAS (Serial Attached SCSI), or the like. The host interface 4212 may also perform a disk emulation function which enables the host 4100 to recognize the SSD 4200 as a hard disk drive (HDD).

The ECC circuit 4213 may generate an error correction code ECC using data transferred to the flash memory 4201 to 420n. The error correction code ECC thus generated may be stored at a spare area of the flash memory 4201 to 420n. The ECC circuit 4213 may detect an error of data read from the flash memory 4201 to 420n. If the detected error is correctable, the ECC circuit 4213 may correct the detected error.

The CPU 4214 may analyze and process signals received from a host 4100 (refer to FIG. 22). The CPU 4214 may control the host 4100 through the host interface 4212 or the flash memories 4201 to 420n through the NVM interface 4211. The CPU 4214 may control the flash memories 4201 to 420n according to firmware for driving an SSD 4200.

The buffer memory 4215 may temporarily store write data provided from the host 4100 or data read from a flash memory. Also, the buffer memory 4215 may store metadata to be stored in the flash memories 4201 to 420n or cache data. At sudden power-off, metadata or cache data stored at the buffer memory 4215 may be stored in the flash memories 4201 to 420n. The buffer memory 4215 may be implemented with a DRAM, an SRAM, and so on.

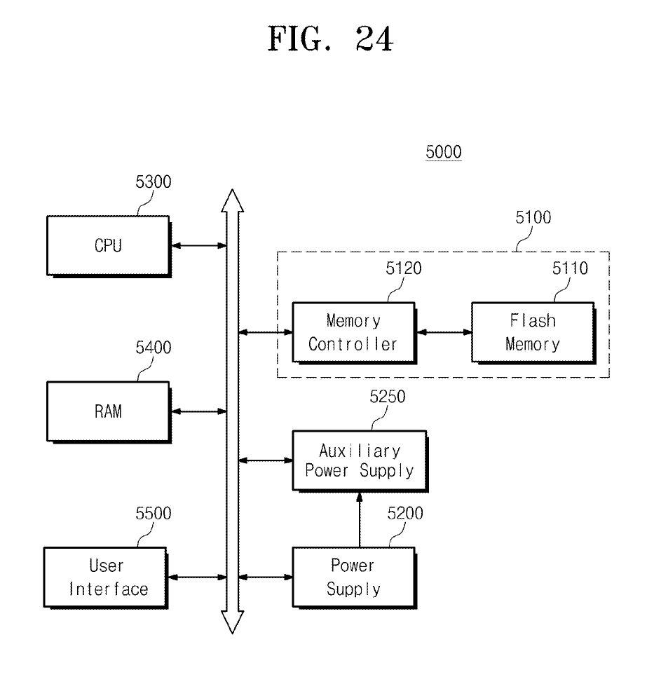

FIG. 24 is a block diagram illustrating an electronic device including a storage device according to an embodiment of the inventive concept. An electronic device 5000 may be implemented with handheld electronic devices, such as a personal computer or a handheld electronic device such as a notebook computer, a cellular phone, a PDA, a camera, and so on.

Referring to FIG. 24, the electronic device 5000 includes a memory system 5100, a power supply 5200, an auxiliary power supply 5250, a central processing unit (CPU) 5300, a random access memory (RAM) 5400, and a user interface 5500. The memory system 5100 contains a flash memory 5110 and a memory controller 5120.

While the inventive concept has been described with reference to exemplary embodiments, it will be apparent to those skilled in the art that various changes and modifications may be made without departing from the scope of the following claims.

What is claimed is:

1. A flash memory based storage system comprising:
a host configured to request erase unit size from a storage device including a flash memory, wherein the storage device is configured to provide the erase unit size related to the flash memory to the host in response to the request for erase unit size,
wherein the host is further configured to partition a logical address using a multiple of the erase unit size to generate a plurality of host blocks.

2. The flash memory based storage system of claim 1, wherein the erase unit size is equal to a multiple of a size of a physical block of the flash memory.

3. The flash memory based storage system of claim 1, wherein each one of the plurality of host blocks is assigned a state selected from a group of states including: an open state in which an erase unit of the storage device is allocated, a write state in which data is written at an erase unit of the storage device, and an invalidate state in which valid data of a host block is invalidated.

4. The flash memory based storage system of claim 1, wherein each one of the plurality of host blocks is assigned a state selected from a group of states including: an open state in which an erase unit of the storage device is allocated, a write state in which data is written at an erase unit of the storage device, a close state in which a write operation is no longer performed, and an invalidate state in which valid data of a host block is invalidated.

5. The flash memory based storage system of claim 4, wherein the host is further configured to communicate a specific vendor command to the storage device to transition a host block into the open state or the close state.

6. The flash memory based storage system of claim 4, wherein the host transitions a host block into the open state or the close state using an argument of a write command or a logical address of the host block.

7. The flash memory based storage system of claim 4, wherein the host is further configured to provide the storage device with a trim command associated with the invalidate state to invalidate valid data of an erase unit allocated to a host block.

8. The flash memory based storage system of claim 4, wherein the host is further configured to invalidate valid data of an erase unit allocated to a host block by removing mapping table information through a state transition for the host block without providing a trim command to the storage device.

9. The flash memory based storage system of claim 1, wherein the storage device is a solid state drive (SSD).

10. An operating method of a flash memory based storage device including a host and a storage device including a flash memory, the method comprising:
requesting that erase unit size related to the flash memory be communicated from the storage device to the host and receiving the erase unit size information in the host; and
partitioning a logical address using a multiple of the erase unit size to generate a plurality of host blocks.

11. The method of claim 10, wherein the erase unit size is equal to a multiple of a size of a physical block of the flash memory.

12. The method of claim 10, further comprising:
assigning to each one of the plurality of host blocks a state selected from a group of states including: an open state in which an erase unit of the storage device is allocated, a write state in which data is written at an erase unit of the storage device, and an invalidate state in which valid data of a host block is invalidated.

13. The method of claim 10, further comprising:
assigning each one of the plurality of host blocks a state selected from a group of states including: an open state in which an erase unit of the storage device is allocated, a write state in which data is written at an erase unit of the storage device, a close state in which a write operation is no longer performed, and an invalidate state in which valid data of a host block is invalidated.

14. The method of claim 13, further comprising:
invalidating valid data of an erase unit allocated to a host block by providing the storage device with a trim command.

15. The method of claim 13, further comprising:
removing mapping table information from a state transition without providing the trim command to the storage device.

16. An operating method of a flash memory based storage device including a host storing a logical address and a storage device including a flash memory divided into a plurality of erase units, the method comprising:
requesting that erase unit size related to the flash memory be communicated from the storage device to the host; and
receiving the erase unit size information in the host and using an integer multiple of the erase unit size to partition the logical address to generate a plurality of host blocks, wherein each one of the host blocks respectively corresponds to at least one of the plurality erase units.

17. The method of claim 16, further comprising:
assigning to each one of the plurality of host blocks a state selected from a group of states including: an open state in which an erase unit of the storage device is allocated, a write state in which data is written at an erase unit of the storage device, and an invalidate state in which valid data of a host block is invalidated.

18. The method of claim 16, further comprising:
assigning each one of the plurality of host blocks a state selected from a group of states including: an open state in which an erase unit of the storage device is allocated, a write state in which data is written at an erase unit of the storage device, a close state in which a write operation is no longer performed, and an invalidate state in which valid data of a host block is invalidated.

19. The method of claim 18, further comprising:
invalidating valid data of an erase unit allocated to a host block by providing the storage device with a trim command.

20. The method of claim 18, further comprising:
removing mapping table information from a state transition without providing the trim command to the storage device.
